(19) United States
(12) Patent Application Publication
(10) Pub. No.: US 2015/0350968 A1
(43) Pub. Date: Dec. 3, 2015

(54) Target Network Node, Source Network Node and Methods for Mobility in a Wireless Communications Network

(71) Applicant: Telefonaktiebolaget L M Ericsson (publ), Stockholm (SE)

(72) Inventors: Icaro L. J. Da Silva, Sollentuna (SE); Angelo Centonza, Winchester (GB)

(21) Appl. No.: 14/236,183

(22) PCT Filed: Jan. 7, 2014
(86) PCT No.: PCT/SE2014/050006

§ 371 Date: Jan. 30, 2014

Related U.S. Application Data
(60) Provisional application No. 61/812,267, filed on Apr. 16, 2013.

(51) Int. Cl. H04W 36/00; H04W 36/14

(52) U.S. Cl. CPC H04W 36/0055; H04W 36/14; H04W 36/0011; H04W 88/08

(57) ABSTRACT

A method in a target network node for applying mobility parameters is provided. The target network node is configured with one or more first mobility parameters. The target network node receives (401) a first message from a source network node. The first message comprises an indication, indicating one or more second mobility parameters associated with a first group of User Equipments, UEs, that are to be handed over from the source network node to the target network node.

The target network node then applies (404) the one or more second mobility parameters for each or any respective User Equipment, UE, of the first group of UEs, being handed over from the source network node to the target network node during a time window.

### TECHNICAL FIELD

Embodiments herein relate to a target network node, a source network node, and methods therein. In particular, it relates to proposing and applying mobility parameters.

### BACKGROUND

Communication devices such as terminals are also known as e.g. User Equipments (UE), mobile terminals, wireless terminals and/or mobile stations. Terminals are enabled to communicate wirelessly in a cellular communications network or wireless communication system, sometimes also referred to as a cellular radio system or cellular networks. The communication may be performed e.g. between two terminals, between a terminal and a regular telephone and/or between a terminal and a server via a Radio Access Network (RAN) and possibly one or more core networks, comprised within the cellular communications network.

Terminals may further be referred to as mobile telephones, cellular telephones, laptops, or surf plates with wireless capability, just to mention some further examples. The terminals in the present context may be, for example, portable, pocket-storable, hand-held, computer-comprised, or vehicle-mounted mobile devices, enabled to communicate voice and/or data, via the RAN, with another entity, such as another terminal or a server.

The cellular communications network covers a geographical area which is divided into cell areas, wherein each cell area being served by an access node such as a base station, e.g. a Radio Base Station (RBS), which sometimes may be referred to as e.g. “eNB”, “eNodeB”, “NodeB”, “B node”, or BTS (Base Transceiver Station), depending on the technology and terminology used. The base stations may be of different classes such as e.g. macro eNodeB, home eNodeB or pico base station, based on transmission power and thereby also cell size. A cell is the geographical area where radio coverage is provided by the base station at a base station site. One base station, situated on the base station site, may serve one or several cells. Further, each base station may support one or several communication technologies. The base stations communicate over the air interface operating on radio frequencies with the terminals within range of the base stations. In the context of this disclosure, the expression Downlink (DL) is used for the transmission path from the base station to the mobile station. The expression Uplink (UL) is used for the transmission path in the opposite direction i.e. from the mobile station to the base station.

In 3rd Generation Partnership Project (3GPP) Long Term Evolution (LTE), base stations, which may be referred to as eNodeBs or even eNBs, may be directly connected to one or more core networks.

3GPP LTE radio access standard has been written in order to support high bitrates and low latency both for uplink and downlink traffic. All data transmission is in LTE may be controlled by the radio base station.

Mobility Load Balance (MLB) is one of the candidate use cases that may benefit from UE grouping strategies i.e. a source cell decide to offload a group of users based on some criteria to a target cell whose load information is known.

Currently, 3GPP specifies the following components for the MLB solution:
Load reporting (not the same for intra-LTE and inter-Radio Access Technology (RAT) in terms of: Load measures, Reporting Procedures,
Load balancing action based on Handovers (HO) s, and
Adapting HO and/or Cell Reselection (CR) configuration so that the load remains balanced.

The load reporting function is executed by exchanging cell specific load information between neighbor eNBs over the X2 interface in an intra-LTE scenario or S1 interface in an inter-RAT scenario where two procedures are involved, Resource Status Initiation X2 and Resource Status Reporting X2 procedure.

Load Reporting:

The Resource Status Initiation X2 procedure is initiated when the load in a first cell A1 served by eNB1 exceeds a threshold. A RESOURCE STATUS REQUEST X2AP message is sent to neighbor base stations such as e.g. an eNB2 and an eNB3. X2AP is the Application Protocol (AP) used to inter-eNB communication. In this case, the RESOURCE STATUS REQUEST is a message defined by this protocol specification in 3GPP. The message indicates that the reporting Periodicity is 1-10 seconds and the load measure to be reported.

In the Resource Status Reporting X2 procedure, a RESOURCE STATUS UPDATE X2AP message is sent to the eNB1 from the neighbor base stations such as e.g. an eNB2 and an eNB3.

Load Balancing Action:

Once the source eNB such as eNB1 has decided the target eNB, such as e.g. eNB2, and which UE's that will be offloaded, it may perform Mobility Parameter Change Procedure followed by ordinary handovers.

Amending Mobility Configuration:

eNB1 sends a MOBILITY CHANGE REQUEST message to eNB2, and in the normal case eNB2 may respond with a MOBILITY CAHNGE ACK. In the case of a, e.g. proposed thresholds not within an allowed range, eNB2 may respond with a MOBILITY CHANGE FAILURE message. Upon the reception of this failure message, eNB1 may send again a MOBILITY CHANGE REQUEST message to eNB2 with another proposed threshold which in turn may be accepted. The eNB2 then sends a MOBILITY CHANGE ACK message to the eNB1

UE grouping brings challenges to all the three functions Load reporting, Load balancing action and amending mobility configuration.

### SUMMARY

It is therefore an object of embodiments herein to improve the performance of a wireless communications network when using UE grouping.

According to a first aspect of embodiments herein, the object is achieved by a method in a target network node for applying mobility parameters. The target network node is configured with one or more first mobility parameters. The target network node receives a first message from a source network node. The first message comprises an indication, indicating one or more second mobility parameters associated with a first group of User Equipments, UEs, that are to be handed over from the source network node to the target network node.

The target network node then applies the one or more second mobility parameters for each or any respective User Equipment, UE, of the first group of UEs, being handed over from the source network node to the target network node during a time window.

According to a second aspect of embodiments herein, the object is achieved by a method in a source network node for proposing mobility parameters to a target network node. The source network node associates second mobility parameters and a group ID with a first group of User Equipments, UEs, that are to be handed over to a target network node. The source network node then sends a first message to the target network node. The first message comprises an indication indicating the first group of UEs that are to be handed over to the target network node, and which first message further indicates the one or more second mobility parameters associated with the group of UEs.

According to a third aspect of embodiments herein, the object is achieved by a target network node for applying mobility parameters. The target network node is configured with one or more first mobility parameters. The target network node comprises a receiving circuit configured to receive a first message from a source network node. The first message comprises an indication, indicating one or more second mobility parameters associated with a first group of User Equipments, UEs, that are to be handed over from the source network node to the target network node. The target network node further comprises a mobility parameter handling circuit configured to apply the one or more second mobility parameters for each or any respective User Equipment, UE, of the first group of UEs, being handed over from the source network node to the target network node during a time window.

According to a fourth aspect of embodiments herein, the object is achieved by a source network node for proposing mobility parameters to a target network node. The source network node comprises an associating circuit configured to associate second mobility parameters and a group ID with a first group of User Equipments, UEs, that are to be handed over to a target network node. The source network node further comprises a sending circuit configured to send a first message to the target network node. The first message comprises an indication indicating the first group of UEs that are to be handed over to the target network node and which first message further indicates the one or more 30 second mobility parameters associated with the group of UEs.

An advantage with embodiments herein is that embodiments herein provide a way to differentiate mobility handling of different groups of UE's. In addition to that, it also provides flexibility to implementation MLB and Mobility Robustness Optimization (MRO) algorithms in the source and target nodes to apply different grouping strategy, depending on the network nodes.

### DETAILED DESCRIPTION

Related technical area may be LTE, Universal Terrestrial Radio Access Network (UTRAN), Enhanced (E)-UTRAN, L3, MLB, MRO, Self-Organizing Network (SON), UE grouping.

Problem

As part of evaluating embodiments herein a problem has first be identified and will be discussed.

A 3GPP Release12 study item on “Next-Generation SON for UTRA and LTE” includes an aspect entitled “SON for UE types” proposing to investigate if SON features specified so far may benefit from knowledge about UE types.

MLB is one of the candidate use cases that may benefit from UE grouping strategies i.e. a source cell decide to offload a group of users based on some criteria to a target cell whose load information is known.

Currently, 3GPP specifies, as mentioned above, the following components for the MLB solution:
Load reporting, not the same for intra-LTE and inter-RAT in terms of: Load measures, Reporting Procedures,
Load balancing action based on handovers (HO)s, and
Adapting HO/CR configuration so that the load remains balanced.

UE grouping brings challenges to all the three functions, but in embodiments herein in focus on the adaptation of HO/CR configuration so that the load remains balanced. This adaptation is performed via the X2 Mobility Change Request procedure which is enhanced according to embodiments herein. In the case of inter-RAT MLB, the procedure is not defined at the standard

To explain the problem solved by the embodiments herein, consider the following scenario. A source eNB-1 (eNB-s) wants to offload a group A of UEs based on its own criteria e.g. low speed UEs or UE's with real-time bearers, or any other grouping criteria. Assuming the source eNB-s has chosen a target eNB-t, the offloading process is done by performing handovers before or after a Mobility Setting Change procedure, where source and target negotiate mobility parameters thresholds e.g. HO/CR margins. This is done in order to make the UE's which have been offloaded to keep connected to their new eNB-t.

Problem 1: The source eNB-s wanted to offload only UE group A but, HO/CR adjustment may also get UE's from different other groups, like the ones from a group B of UEs.

Before a load balancing action involving handovers is taken, the X2 Mobility Settings Change procedure may be run. By means of the MOBILITY CHANGE REQUEST/RESPONSE eNBs negotiate new mobility thresholds. However, these thresholds, according to current standardized procedures, are generic. Namely, the new thresholds may be applied to all UEs in the pair of cells for which the Mobility Setting Change negotiation was carried out, i.e. the cells associated with eNB-s and eNB-t.

Once a group A of UE is handed over to eNB-t, HO/CR margins adjustment settings, either negotiated via Mobility Setting Change or deduced by eNB-t, are applied in order to avoid these group A UE's to come back to eNB-s, which may be quite critical under an overloading scenario. However, if assuming that a certain UE grouping, such as group A UEs is in place in eNB-s, e.g. based on the type of bearers the UEs are using, though these margins could be interpreted as recommended per group, they may be applied to other UE's in the same range, which might affect e.g. UE's from group B. This scenario may lead to suboptimal load balancing. The reason is that for example, UEs supporting e.g. non real time services may be suitable for more aggressive offloading procedures, for which even if the handover was subject to failure, the user experience would not be affected. Hence, if the current Mobility Setting Change procedures and the concept of UE grouping need to be supported together, some enhancements are needed to current standard specifications.

This problem occurs because when mobility settings are changed in eNB-t, it might occur that eNB-t not only applies such HO setting changes to the new incoming group A UE's from eNB-s, but also the UE's in eNB-t in RRC_CONNECTED. These new settings are signalled to the UEs via RrcConnection_reconfiguration. Moreover, group B UE's in RRC_IDLE camped on eNB-s may perform cell reselection and camp in eNB-t. Therefore, settings which were applied focusing only on group A would affect group B UE's when they go to RRC_CONNECTED.

Problem 2. UE's such as e.g. the group A UEs that have been just handed over to eNB-t are reclassified according to new grouping criteria and may be handed over again to eNB-s.

The second problem arises when the target eNB-t has a different type of MLB grouping strategy. In this scenario, assume that eNB-t has a different group strategy called e.g. group C. In this case, when group A UE's have just connected to eNB-t, they receive the new HO settings that may have been negotiated via Mobility Settings Change, but at some point, they should be re-classified according to eNB-t grouping criteria. It could be the case that after re-classification and signaling to the group A UEs of new mobility parameters, which may run periodically or after the RRC setup, all the UEs belong now to group C, which may have a different settings leading to HO back to eNB-s or to another eNB.

In the current standards there is no solution for the Mobility Parameter Change procedure to support UE grouping strategies for MLB. On the other hand, some discussions in 3GPP points to a solution of standard-defined grouping strategies which relies on the following principle:

There would be grouping strategies for MLB defined by 3GPP. This means that nodes from all the vendors have to agree upon the grouping strategies in 3GPP which are relevant to load balance performance.

Following this principle, the existing solution under discussion for the Mobility Parameter Change procedure would be the following:

1—The source eNB-s has a set of groups {1, 2, . . . , N} where UE's are classified. When overloading is detected, MLB function decides which group will be handed over to a target eNB-t, which also have the same groups {1, 2, . . . , N}. Assume that source eNB-s decides to offload the n-th group.

2—During the Mobility Parameter Change procedure, instead of informing the target eNB-t a single parameter, it informs parameters settings per groups or only the new setting for the n-th group.

3—Since the groups are the same in both nodes, target eNB-t may apply the new settings to UE's belonging to the n-th group.

Although this solution solves the same problem, the embodiments herein are intended to solve, some problems are highlighted for the existing solution:

1—The solution limits the potential for new grouping strategies in the future, locking strategies which might be considered important in further standard enhancements. For example, if it is decided that UE's should be grouped only based on speed and UE capabilities, there won't be chance in the future to add a new grouping criteria e.g. based on bearer type or user behavior using data from Operation and Support System (OSS)/Business Support System (BSS).

2—There is a clear lack of flexibility for implementation-differentiation of MLB strategies. There will be less potential for implementation differentiation when it comes to load balancing based on UE grouping, since all the vendors would implement the same grouping criteria.

Operations and Management (OAM) Architecture

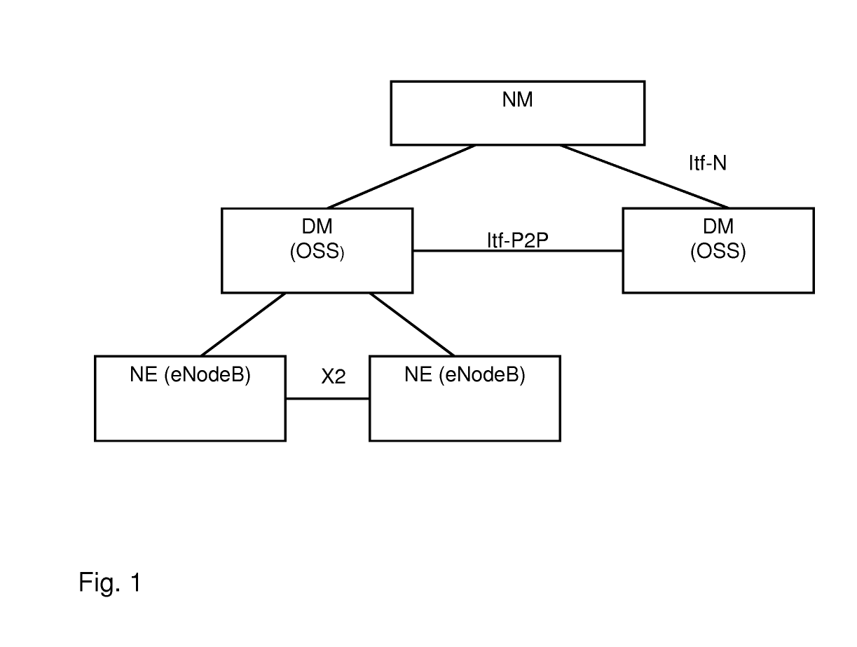

An management system assumed according to embodiments herein is shown in FIG. 1. Node Elements (NE), also referred to as eNodeB, first network node, source eNB, eNB-s, eNB-1, eNB-2, eNB3 or source network node, second network node, target eNB, eNB-t or target network node, are managed by a Domain Manager (DM), also referred to as the OSS. A DM may further be managed by a network manager (NM). Two NEs are interfaced by X2, whereas the interface between two DMs is referred to as Itf-P2P. The management system may configure the network elements, as well as receive observations associated to features in the network elements. For example, DM observes and configures NEs, while NM observes and configures DM, as well as NE via DM.

Embodiments Herein Relies on the Following Principle:

Each node, such as a source network node will have the flexibility to apply its own UE grouping criteria. Node coordination, more critical in multi-vendor scenario, is achieved by a time-based master-slave scheme which occurs during the Mobility Load Balance procedure. The Mobility parameter change is enhanced by a generic grouping identification.

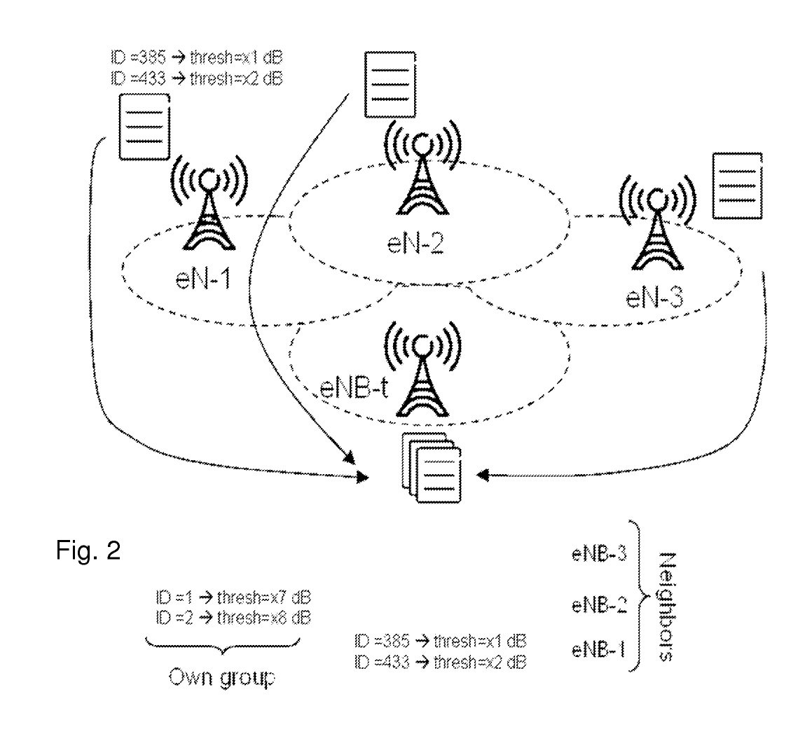

Example of embodiments herein comprises a method where each node, such as the source network node builds or creates a list of groups associated to its neighbor network nodes and mobility settings associated to these groups per node, as depicted in FIG. 2.

FIG. 2 shows list of groups per neighbor and mobility settings associated to these groups.

Note that the description of the problems, scenarios and solutions described herein refer only to a particular instance of the problem occurrence, i.e. the case of mobility load balancing between LTE cells. This shall not restrict the use of the principles behind the proposed solutions to other scenarios involving different source or target RATs.

### TERMINOLOGIES

The following commonly terminologies are used in embodiments herein and are elaborated below:

Radio network node: In some embodiments the non-limiting term radio network node is more commonly used and it refers to any type of network node serving UE and/or connected to other network node or network element or any radio node from where UE receives signal. Examples of radio network nodes are Node B, base station (BS), multi-standard radio (MSR) radio node such as MSR BS, eNode B, network controller, radio network controller (RNC), base station controller, relay, donor node controlling relay, base transceiver station (BTS), access point (AP), transmission points, transmission nodes, RRU, RRH, nodes in distributed antenna system (DAS) etc.

Network node: In some embodiments a more general term “network node” is used and it can correspond to any type of radio network node or any network node, which communicates with at least a radio network node. Examples of network node are any radio network node stated above, core network node (e.g. MSC, MME etc.), O&M, OSS, SON, positioning node (e.g. E-SMLC), MDT etc.

User equipment: In some embodiments the non-limiting term user equipment (UE) is used and it refers to any type of wireless device communicating with a radio network node in a cellular or mobile communication system. Examples of UE are target device, device to device UE, machine type UE or UE capable of machine to machine communication, PDA, iPad, Tablet, mobile terminals, smart phone, laptop embedded equipped (LEE), laptop mounted equipment (LME), USB dongles etc.

The embodiments herein also apply to the multi-point carrier aggregation systems.

Note that although terminology from 3GPP LTE has been used in this disclosure to exemplify the embodiments herein, this should not be seen as limiting the scope of the embodiments herein to only the aforementioned system. Other wireless systems, including WCDMA, WiMax, UMB and GSM, may also benefit from exploiting the ideas covered within this disclosure.

Also note that terminology such as eNodeB and UE should be considering non-limiting and does in particular not imply a certain hierarchical relation between the two; in general “eNodeB” could be considered as device 1 and “UE” device 2, and these two devices communicate with each other over some radio channel. Herein, we also focus on wireless transmissions in the downlink, but the embodiments herein are equally applicable in the uplink.

In this section, the embodiments herein will be illustrated in more detail by a number of exemplary embodiments. It should be noted that these embodiments are not mutually exclusive. Components from one embodiment may be tacitly assumed to be present in another embodiment and it will be obvious to a person skilled in the art how those components may be used in the other exemplary embodiments.

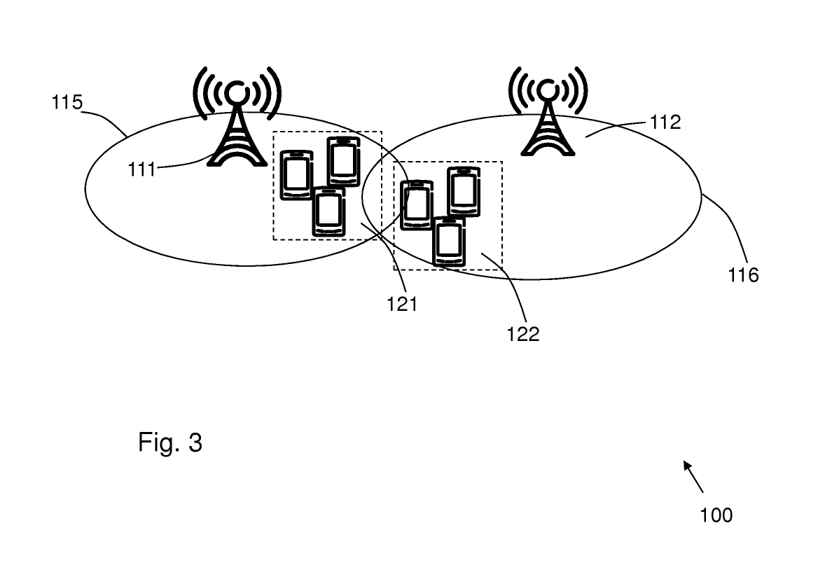

An example of a wireless communications network 100 in which embodiments herein may be implemented is depicted in FIG. 3. The wireless communications network 100 is a wireless communication network such as an LTE, WCDMA, GSM network, any 3GPP cellular network, Wimax, or any cellular network or system.

The wireless communications network comprises a plurality of network nodes whereof for example, a source network node 111 and a target network node 112. The source network node 111 serves a source cell 115 and a target network node 112 serves a target cell 116. The source network node and the target network node may each be a transmission point such as a radio base station, for example an eNB, an eNodeB, or a Home Node B, a Home eNodeB or any other network node capable to serve a user equipment or a machine type communication device in a wireless communications network.

A first group of UEs 121 and a second group of UEs 122 also referred to as user equipments are located in the wireless communication network. Each user equipment may e.g. be a wireless device, a mobile terminal or a wireless terminal, a mobile phone, a computer such as e.g. a laptop, a Personal Digital Assistants (PDAs) or a tablet computer, sometimes referred to as a surf plate, with wireless capability, or any other radio network units capable to communicate over a radio link in a wireless communications network. Please note the term user equipment used in this document also covers other wireless devices such as Machine to machine (M2M) devices, even though they do not have any user.

The source network node 111, the target network node 112 and the respective UE in the first and second groups 121, 122 may comprise an interface unit to facilitate communications between the UE and other nodes or devices. The interface may, for example, include a transceiver configured to transmit and receive radio signals over an air interface in accordance with a suitable standard.

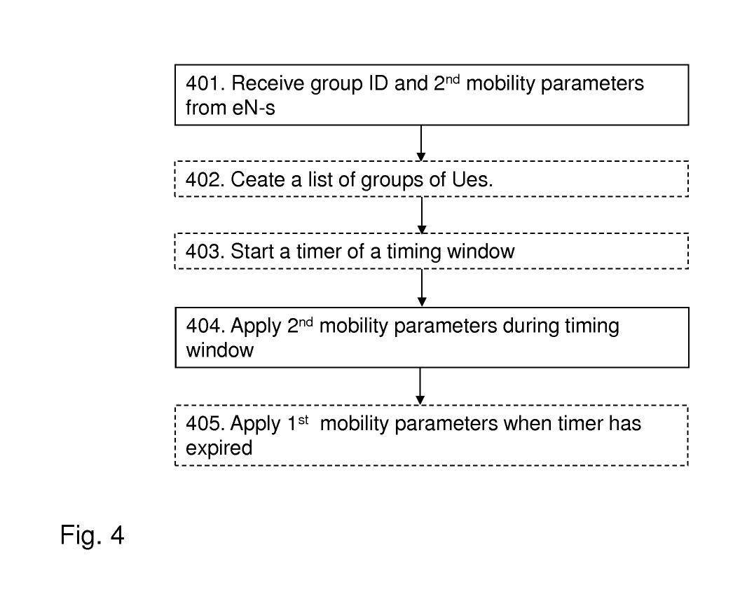

Example of embodiments of a method in a target network node 112 for applying mobility parameters will now be described with reference to a flowchart depicted in FIG. 4. The target network node 122 is configured with one or more first mobility parameters. The method will first be described in a general manner, a more detailed description will follow below.

The method comprises the following actions, which actions may be taken in any suitable order. Dashed lines of some boxes in FIG. 4 indicate that this action is not mandatory.

Action 401

The target network node 112 receives a first message from a source network node 111. The first message comprises an indication, indicating one or more second mobility parameters associated with the first group of UEs 121. The first group of UEs 121 are to be handed over from the source network node 111 to the target network node 112.

The one or more second mobility parameters may comprise a hand over trigger change and the time window.

In some embodiments, the one or more second mobility parameters comprise a hand over trigger change. In these embodiments, the target network node 112 is configured with the time window.

In some embodiments, the first message may further indicate a group ID associated with the first group of UEs 121.

Action 402

In some embodiments, the first message further comprises a respective group ID for one or more second groups of UEs 122 and indicates one or more third mobility parameters associated with the respective one or more second group of UEs 122. In these embodiments, the target network node 112 may create a list of groups of UEs comprising the first group of UEs 121 and the one or more second group of UEs 122, and the group ID and associated mobility parameters of the respective group of UEs.

Action 403

In some embodiments, when the target network node 112 has been configured with the one or more second mobility parameters indicated in the first message, the target network node 112 starts a first timer of the time window.

Action 404

The target network node 112 applies the one or more second mobility parameters for each or any respective UE of the first group of UEs 121 being handed over from the source network node 111 to the target network node 112 during a time window.

In some embodiments, the one or more second mobility parameters further are applied for each or any other respective UE being handed over from the source network node 111 to the target network node 112 during the time window.

During the time window, the target network node 112 may apply further a classification algorithm of the source network node 111. The classification relates to dividing UEs into groups.

Action 405

In some embodiments, when the first timer has expired, the target network node 112 applies the one or more first mobility parameters for each or any respective UE of the first group of UEs 120 and each or any other respective UE being handed over from the source network node 111 to the target network node 112.

When the first timer has expired, the target network node 112 may apply further a classification algorithm of the target network node 111.

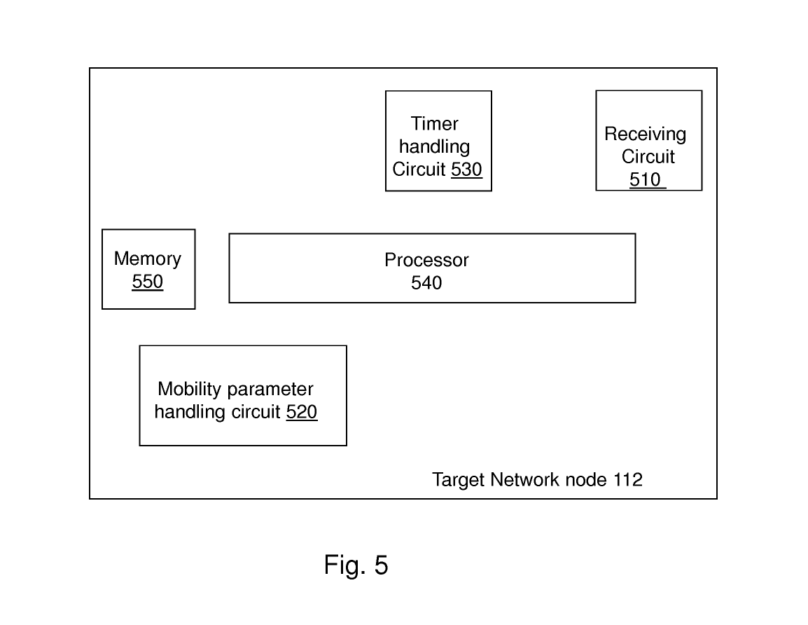

To perform the method actions for applying mobility parameters, described above in relation to FIG. 4, the target network node 112 may comprise the following arrangement depicted in FIG. 5. As mentioned above the target network node 122 is configured with one or more first mobility parameters.

The target network node 112 comprises a receiving circuit 510 configured to receive a first message from a source network node 111. The first message comprises an indication, indicating one or more second mobility parameters associated with a first group of UEs 121 that are to be handed over from the source network node 111 to the target network node 112.

In some embodiments the one or more second mobility parameters comprises a hand over trigger change and the time window.

The one or more second mobility parameters may comprise a hand over trigger change, and wherein the target network node 112 is configured with the time window.

The first message may further indicate a group ID associated with the first group of UEs 121.

The target network node 112 further comprises a mobility parameter handling circuit 520 configured to apply the one or more second mobility parameters for each or any respective User Equipment, UE, of the first group of UEs, 121 being handed over from the source network node 111 to the target network node 112 during a time window.

The mobility parameter handling circuit 520 may further be configured to apply the one or more second mobility parameters for each or any other respective UE being handed over from the source network node 111 to the target network node 112 during the time window.

In some embodiments the mobility parameter handling circuit 520 further is configured to, when the first timer has expired, apply the one or more first mobility parameters for each or any respective UE of the first group of UEs, 120 and each or any other respective UE being handed over from the source network node 111 to the target network node 112.

The mobility parameter handling circuit 1120 may further be configured to:

During the time window, apply a classification algorithm of the source network node 111, which classification relates to dividing UEs into groups, and

when the first timer has expired, apply a classification algorithm of the target network node 111.

The target network node 112 may further comprise a timer handling circuit 530 configured to start a first timer of the time window when the target network node 112 has been configured with the one or more second mobility parameters indicated in the first message.

In some embodiments, the first message further comprises a respective group ID for one or more second groups of UEs 122 and indicates one or more third mobility parameters associated with the respective one or more second group of UEs 122. In these embodiments, the target network node 112 may further comprise a processor 540 configured to create a list of groups of UEs comprising the first group of UEs 121 and the one or more second group of UEs 122, and the group ID and associated mobility parameters of the respective group of UEs.

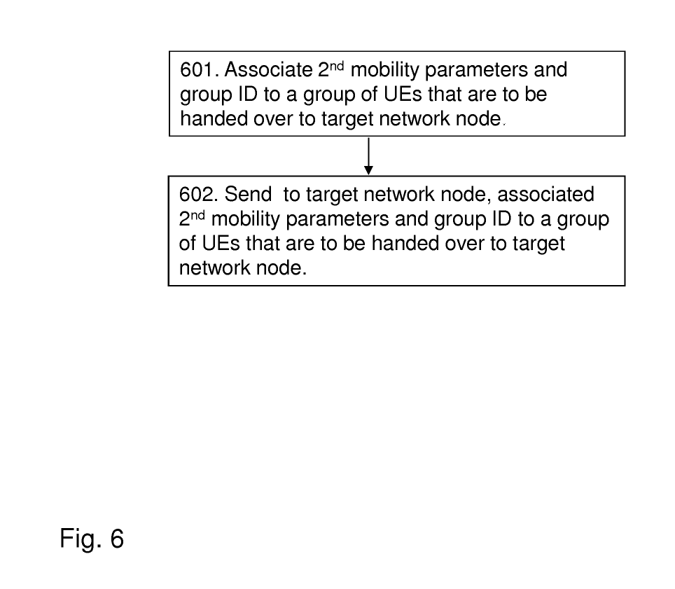

Embodiments herein will now be described in perspective seen from the source network node 111 in a general way. Thus, example of embodiments of a method in the source network node 111 for proposing mobility parameters to the target network node 112 will be described with reference to a flowchart depicted in FIG. 6.

The method will first be described in a general manner, a more detailed description will follow below.

The method comprises the following actions, which actions may be taken in any suitable order. Dashed lines of some boxes in FIG. 4 indicate that this action is not mandatory.

Action 601

The source network node 111 associates second mobility parameters and a group ID with a first group of UEs 120 that are to be handed over to a target network node.

Action 602

The source network node 111 sends a first message to the target network node 112. The first message comprises an indication indicating the first group of UEs 120 that are to be handed over to the target network node 112. The first message further indicates the one or more second mobility parameters associated with the group of UEs 120. The second mobility parameters may be proposed to the target network node 122.

The first message may further comprise an indication indicating the group ID associated to the group of UEs 120 that are to be handed over to the target network node 112.

In some embodiments, the one or more second mobility parameters comprises a hand over trigger change, or the one or more second mobility parameters comprises a handover trigger change and a time window. During the time window, the target node 112 shall apply the one or more second mobility parameters for each or any respective UE of the first group of UEs 120 being handed over from the source network node 111 to the target network node 112.

The first message may further comprise a respective group ID for the one or more second groups of UEs 122 and indicating one or more third mobility parameters associated with the respective one or more second group of UEs 122.

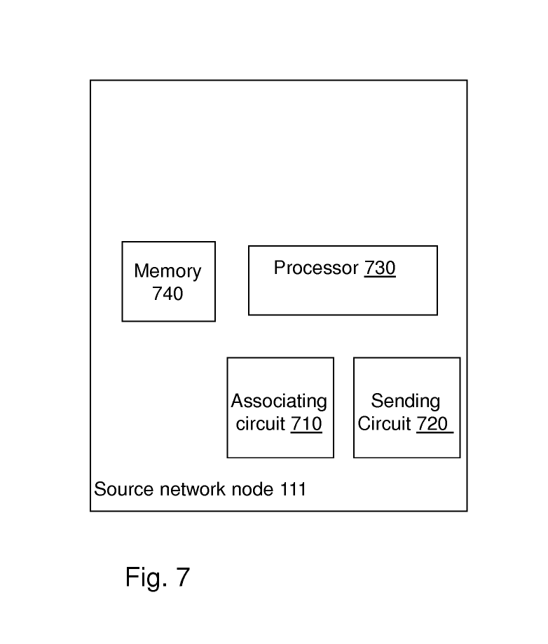

To perform the method actions for proposing mobility parameters to a target network node 112, described above in relation to FIG. 6, the source network node 111 comprises the following arrangement depicted in FIG. 7.

The source network node 111 comprises an associating circuit 710 configured to associate second mobility parameters and a group ID with a first group of UEs 120 that are to be handed over to a target network node.

The source network node 111 further comprises a sending circuit 720 configured to send a first message to the target network node 112. The first message comprises an indication indicating the first group of UEs 120 that are to be handed over to the target network node 112. The first message further indicates the one or more second mobility parameters associated with the group of UEs 120.

In some embodiments, the second mobility parameters are to be proposed to the target network node 122.

The first message may further comprise an indication indicating the group ID associated to the group of UEs 120 that are to be handed over to the target network node 112.

In some embodiments, the one or more second mobility parameters comprise a hand over trigger change. Or in some other embodiments, the one or more second mobility parameters comprise a hand over trigger change and a time window. During the time window the target node 112 shall apply the one or more second mobility parameters for each or any respective UE of the first group of UEs 120 being handed over from the source network node 111 to the target network node 112.

The first message may further comprise a respective group ID for one or more second groups of UEs 122 and indicate one or more third mobility parameters associated with the respective one or more second group of UEs 122.

Embodiments herein will now be described more in detail. The following text relates to any suitable embodiments above or below.

The source network node 111 will in the text below be referred to as source eNB, eNB-s, source eNB-s or eNB1. The target network node 111 will in the text below be referred to as target eNB, eNB-t or target eNB-t. The first or second groups of UEs 121, 122, will in the text below be referred to as UE group or group of UEs.

The method comprises in enhancing the Mobility Parameter Change procedure by e.g. having an Information Element (IE), for example called List of eNB1, Mobility Parameters, in a MOBILITY CHANGE REQUEST message which comprises thresholds of the source eNB1, associated to which group ordered per group Ordered hear mean respective to the group ID order The same message may comprise another IE with the group IDs e.g. 10, 21, 33. In this case, the IE with the parameters in the same message may contain the values −2, 0, −3 that would be associated to group ID's 10, 21, 33 respectively. The list may be built or updated each time a MOBILITY CHANGE REQUEST is received in the target eNB with the group ID whose threshold is proposed to be changed. This relates to Action 402.

Some embodiments comprise a method which uses these lists in order to avoid ping-pongs or grouping conflicts during UE-group based MLB. Before the source eNB-s decides to handover a group of UE's it may send MOBILITY CHANGE REQUEST indicating the group ID associated to the UE's such as the first group of UEs 121 that are being handed over and the new threshold for that group ID. Assuming that the values are accepted by the target eNB and that the reported group ID is already on the list, the threshold value is updated. In the case the reported group ID is not on the list, the target eNB may respond with a MOBILITY CHANGE FAILURE asking for the current parameter value instead of only the delta, i.e. the difference. Alternatively, it may be assumed that the grouping IDs associated to neighbors could be configured via Domain Management (DM) or the Network Management System (NMS).

When this value is updated at the target node, a timer T0 may be started and, during a pre-defined time window Group Validity Time, the new incoming UE's such as the first group of UEs 121, from the source eNB will get the negotiated mobility parameters settings e.g. via RRC CONNECTION RECONFIGURATION. In other words, the target cell obeys the grouping strategy from the source cell during the pre-defined time window Group Validity Time, which may be adjusted e.g. via a domain manager. This may be seen as the target working as a slave of the source cell during this time.

As explained in the background, UE grouping may be dynamic, static or a combination of both. The nodes such as the source network node 121 and the target network node 122 may have their own grouping criteria for MLB, and it may run a classification algorithm which groups UE's according to their dynamic behavior e.g. speed and bearer type. This algorithm may run periodically or may be triggered by some internal node events such as a change in speed or bearer type. When the timer expires, the UE grouping algorithm at the target node runs and may re-classify these UE's based on its own grouping strategy.

This may be seen as the end of the master-slave relation period between eNBs performing load balancing.

Potential conflicts in the case of vendors using very different algorithms may be solved by adapting the time window Group Validity Time or simply turning MLB off in the slave nodes based on collected statics showing the existence of a clear master in the network.

In some example embodiments herein, it is further assumed that any function that automatically optimizes NE parameters may in principle execute in the NE, DM, or the NMS. Such features are referred to as SON features.

The example method comprises enhancing the Mobility Parameter Change procedure by adding new Information Elements (IEs), including a UE group Identity (ID) Information Element (IE), to the MOBILITY CHANGE REQUEST message and the equivalent responses together with the mobility threshold associated, as shown in Table 1.

This message is sent by an eNB, such as the source network node 111 to neighbouring eNB₂ to initiate adaptation of mobility parameters. Direction: eNB₁→eNB₂ such as the target network node 112.

TABLE 1
Enhanced MOBILITY CHANGE REQUEST message

| | | | IE type and | Semantics | | Assigned |
|---|---|---|---|---|---|---|
| | Presence | Range | reference | description | Criticality | Criticality |
| IE/Group Name | | | | | | |
| Message Type | M | | 9.2.13 | | YES | reject |
| eNB1 Cell ID | M | | ECGI | | YES | reject |
| | | | 9.2.14 | | | |
| eNB2 Cell ID | M | | ECGI | | YES | reject |
| | | | 9.2.14 | | | |
| eNB1 Mobility | O | | Mobility | Configuration | YES | ignore |
| Parameters | | | Parameters | change in eNB₁ | | |
| | | | Information 9.2.48 | cell | | |
| eNB2 Proposed | M | | Mobility | Proposed | YES | reject |
| Mobility | | | Parameters | configuration | | |
| Parameters | | | Information 9.2.48 | change in eNB₂ | | |
| | | | | cell | | |
| UE Group | | | | | | |
| Parameters List | | | | | | |
| >List of | | 1 . . . | | List of per UE | EACH | ignore |
| eNB1 | | <maxnoof | | group | | |
| Mobility | | UEgroups> | | Configuration | | |
| Parameters | | | | changes in eNB₁ | | |
| | | | | cell | | |
| >>Group | O | | INTEGER | Identifies a | — | — |
| ID | | | (1 . . . 256, . . .) | group of UEs as | | |
| | | | | defined by eNB₁ | | |
| >>Handover | O | | INTEGER | The actual value | — | — |
| Trigger | | | (−20 . . . 20) | is IE value * 0.5 | | |
| Change | | | | dB. | | |
| >List of | | 1 . . . | | List of per UE | EACH | ignore |
| Proposed | | <maxnoof | | group | | |
| eNB2 | | UEgroups> | | Configuration | | |
| Mobility | | | | changes | | |
| Parameters | | | | proposed in | | |
| | | | | eNB₂ cell | | |
| >>Group | O | | INTEGER | Identifies a | — | — |
| ID | | | (1 . . . 256, . . .) | group of UEs as | | |
| | | | | defined in eNB2 | | |
| >>Handover | O | | INTEGER | The actual value | — | — |
| Trigger | | | (−20 . . . 20) | is IE value * 0.5 | | |
| Change | | | | dB. | | |
| >>Group | O | | INTEGER | Time in seconds | — | — |
| Validity | | | (1 . . . 4095, . . .) | for which the UE | | |
| Time | | | | suggested | | |
| | | | | changes shall | | |
| | | | | apply to the UE | | |
| | | | | group. | | |
| Cause | M | | 9.2.6 | | YES | reject |

In Table 1, IE/Group name is a description of the information being sent understood by both transmitting/receiving nodes. The “presence” M means the field is mandatory in the protocol message and O means optional. The Range is the range of parameters. IE type or reference is related to the type of parameters according to the 3GPP specifications and the reference to the specification where the parameters are described.

The List of eNB1 Mobility Parameters IE comprises a list of the changes of the Handover Trigger per UE group ID defined in eNB1, as compared to its current handover trigger parameters values. The Handover Trigger corresponds to a threshold between source and target cell signal at which a cell initializes the handover preparation procedure towards a specific neighbour cell. Positive value of the change means the handover is proposed to take place later.

Equivalently, the List of Proposed NB2 Mobility Parameters IE comprises a list of the changes of the Handover Trigger per UE group ID defined in eNB2, as compared to its current handover trigger parameters values currently known to eNB1. Namely, the Group ID IE in the List of Proposed NB2 Mobility Parameters IE is the identifier of the group of UEs with the same Group ID in eNB1. eNB 2 may consider the group identity assigned by eNB1 for a group of UEs as valid for a certain time window and it may apply changes to the mobility parameters settings to all the UEs in that group.

The List of Proposed NB2 Mobility Parameters IE may also comprise a Group Validity Time IE, which represents the time for which eNB2 should consider the proposed mobility setting changes applicable to the group of UEs identified by the Group ID IE.

### Example

Assume that eNB1 with 4 defined groups with IDs 1,2,3,4 performed MLB to group ID=2 towards eNB2. Then, assume that −1 dB has to be added for that group in the source eNB1. The List of eNB1 Mobility Parameters IE will be:

> List of eNB1 Mobility Parameters

>> Group ID == 1
>> Handover Trigger Change == 0
>> Group ID == 2
>> Handover Trigger Change == −2 (−2*0.5=−1dB)
>> Group ID == 3
>> Handover Trigger Change == 0
>> Group ID == 4
>> Handover Trigger Change == 0

At the target eNB2 this is interpreted as eNB1 having 4 group ID 1,2,3,4 and a change is being requested for the group ID=2. Also, eNB1 may indicate only the group which is subject to changes, i.e. group 2.

Similarly, assume that eNB1 request eNB2 to perform a change of +2 dB for UE's from eNB1's group ID=2 and that such adjustment should be valid for 60 seconds. In this case, The List of Proposed eNB2 Mobility Parameters IE will be:

List of Proposed eNB2 Mobility Parameters

>> Group ID == 1
>> Handover Trigger Change == 0
>> Group Validity Time == 0
>> Group ID == 2
>> Handover Trigger Change == +4 (4*0.5=−2dB)
>> Group Validity Time == 60
>> Group ID == 3
>> Handover Trigger Change == 0
>> Group Validity Time == 0
>> Group ID == 4
>> Handover Trigger Change == 0
>> Group Validity Time == 0

This is interpreted as a request to change group ID=2 in+2 dB for 60 seconds. Also, eNB1 may indicate only the group which is subject to changes, i.e. group 2.

A further enhancement of the method may comprise enhancing the Mobility Settings Change procedure by adding an IE called group acknowledgement to the MOBILITY CHANGE ACKNOWLEDGE, as shown in Table 2

TABLE 2

| | | | | | | |
|---|---|---|---|---|---|---|
| | | | IE type and | Semantics | | Assigned |
| IE/Group Name | Presence | Range | reference | description | Criticality | Criticality |

| | | | | |
|---|---|---|---|---|
| Message Type | M | 9.2.13 | YES | reject |
| eNB1 Cell ID | M | ECGI | YES | reject |
| | | 9.2.14 | | |
| eNB2 Cell ID | M | ECGI | YES | reject |
| | | 9.2.14 | | |
| Criticality | O | 9.2.7 | YES | ignore |
| Diagnostics | | | | |
| Group Ack | O | ENUMERATED | YES | ignore |
| | | (True, . . .) | | |

This new IE may be either a single value or a list of IEs, where acknowledgement is given per group ID indicated in the List of Proposed eNB2 Mobility Parameters IE. The IE basically confirms whether the target node is adopting grouping strategy or not. This may be beneficial for further MLB decisions towards this node.

The method further comprises enhancing the Mobility Parameter Change procedure by adding an IE called group acknowledgement to the MOBILITY CHANGE FAILURE, as shown in the Table 2

TABLE 3

| | | | IE type and | Semantics | | Assigned |
|---|---|---|---|---|---|---|
| IE/Group Name | Presence | Range | reference | description | Criticality | Criticality |
| Message Type | M | | 9.2.13 | | YES | reject |
| eNB1 Cell ID | M | | ECGI | | YES | ignore |
| | | | 9.2.14 | | | |
| eNB2 Cell ID | M | | ECGI | | YES | ignore |
| | | | 9.2.14 | | | |
| Cause | M | | 9.2.6 | | YES | ignore |
| >List of failed | | 1 . . . | | List of per UE | EACH | ignore |
| Mobility Parameters | | <maxnoof | | group | | |
| | | UEgroups> | | Configuration | | |
| | | | | changes failed in | | |
| | | | | eNB₂ cell | | |
| >>Group ID | O | | INTEGER | Identifies a group | — | — |
| | | | (1 . . . 256, . . .) | of UEs as defined | | |
| | | | | in eNB2 | | |
| >>Failure Indication | O | | ENUMERATED | Indicates if the | | |
| | | | (True, . . .) | suggested | | |
| | | | | mobility | | |
| | | | | parameters | | |
| | | | | change failed for | | |
| | | | | the associated UE | | |
| | | | | group ID | | |
| Criticality Diagnostics | O | | 9.2.7 | | YES | ignore |

Alternatively, the MOBILITY CHANGE FAILURE may include one generic IE indicating failure for all the suggested mobility parameters changes per UE group from eNB1 to eNB2.

Master—Slave Scheme

In some first embodiments, the target node 112 receiving the MOBILITY CHANGE REQUEST messages described above may create a list for each requesting node with the reported group IDs and associated parameters. These values in this list may be updated each time a new MOBILITY CHANGE REQUEST is received from the same source node.

The group IDs indicated by each neighbour eNB may have been configured in the receiving eNB such as the target network node 112. For example, the grouping criteria for each group ID may have been previously configured by the OAM system.

These lists are used in order to avoid ping-pongs or grouping conflicts during UE-group based MLB. When a source eNB-s decides to handover a group of UE's it sends MOBILITY CHANGE REQUEST with the group ID that is being handed over and its new threshold. The receiving eNB/such as the target network node 112 will know by previous configuration the criteria according to which every Group ID identifies a group of UEs (e.g. by means of UE capabilities, supported bearer type etc.) If the values are accepted by the target eNB and if the reported group ID is on the list the following actions are performed:
The threshold value suggested by the source node is updated for the incoming UE's (e.g. via RRC Connection Reconfiguration) that fall within the grouping criteria associated to the group ID. The mobility parameters will keep according to suggested changes while the value of the timer T0 is within the time window Group Validity Time for that particular Group ID, i.e. T0<Group Validity Time.
If the timer expires, the classification algorithm in the target eNB may set a new threshold according to the grouping strategy of the target eNB.

In some second embodiments, the change of mobility parameters regards a single group of UEs. Namely the new IEs contained in the MOBILITY CHANGE REQUEST message only report one group ID and associated IEs. When the suggested mobility parameters are updated at the target node, a new timer T1 is started. During this time the eNB2 such as the target network node will monitor the number of UEs handing in from the cell in eNB1 such as the source network node with which the new mobility parameters were negotiated. These UEs will form the group indicated in the MOBILITY CHANGE REQUEST message by eNB1.

In eNB2/such as the target network node a timer T0 is then started and, during a pre-defined time window Group Validity Time defined for the UE group, the new incoming UE's from the source eNB will get the negotiated settings. This may be done for example via RRC CONNECTION RECONFIGURATION. In other words, the target cell obeys the grouping strategy from the source cell during the pre-defined time window Group Validity Time. Note that the Group Validity Time in this case may not be signaled as part of the MOBILITY CHANGE REQUEST message, but could be configured, for example by Domain Manager for each eNB. This may be seen as the target network node 112 working as a slave of the source cell during this time.

As explained in the background, UE grouping may be dynamic, static or a combination of both. The network nodes 111, 112 may have their own grouping criteria for MLB, and it runs a classification algorithm which groups UE's according to their dynamic behavior e.g. speed, bearer type, etc. This algorithm may run periodically or triggered by some internal node events such as a change in speed or bearer type. When the timer T0 expires the UE grouping algorithm at the target node runs and may re-classify these UE's based on its own grouping strategy. This may be seen as the end of the slavery period.

In another embodiment a method is considered that configures the nodes such as the source and target network nodes 111, 112, with the group IDs of their neighbors and the initial values for mobility settings. In this method the MLB algorithm generate group IDs for each group strategy and set initial values. These group IDs and corresponding values may be send to, or accessed by, the DM. Then, the DM may configure the nodes with neighbors information about their groups and initial thresholds.

For completeness, an alternative may be considered, where this initial group information may be self-configured via X2. In this case, during X2 setup phase, a neighbor is able to request the group IDs and initial mobility settings.

Potential conflicts in the case of vendors using very different algorithms could be solved by adapting the time window Group Validity Time or simply turning MLB off in the slavery nodes based on collected statics showing the existence of a clear master in the network.

Alternatives for the Messages

The new lists may be built each time a MOBILITY CHANGE REQUEST is received with the group IDs whose threshold is proposed to be changed.

For this case the acknowledgement message and the failure message may follow the structure of messages in Table 2 and Table 3.

Handling of Cell Reselection Parameters

Source nodes may associate one of groups to set cell reselection settings. Alternatively, the target node could decide by itself which settings are more suitable.

Handling of the IRAT Case

The same principles may be applied to IRAT scenarios except that the enhancements we proposed could be performed in the RIM procedure to exchange mobility parameters. The timer concept also applies, where we assume that e.g. LTE could always be the master RAT i.e. giving the group policies to the lower priority RAT.

Embodiments herein addressed a solution which brings some flexibility to implementation MLB algorithms to apply different grouping strategy, depending on the nodes. Not only each vendor may apply their own criteria, but eventually the same vendor may apply different grouping criteria in different parts of the network.

Node interoperability is guaranteed and a future-poof standard solution.

Embodiments herein avoids that a grouping criteria and mobility parameters setting established by one eNB have to be supported and respected by a neighbour eNB involved in MLB procedures. Such behavior is against the flat architecture most mobile network RAN architectures are based on. On the contrary, embodiments herein allows every base station to temporarily acknowledge the mobility policies supported by a neighbour base station, but then to detach from them and adopt what it is believed to be the best mobility policy.

The embodiments herein may be implemented through one or more processors, such as a processor 540 in the target network node depicted in FIG. 5, and a processor 730 in the source network node depicted in FIG. 7, together with computer program code for performing the functions and actions of the embodiments herein. The program code mentioned above may also be provided as a computer program product, for instance in the form of a data carrier carrying computer program code for performing the embodiments herein when being loaded into the in the target network node or the source network node. One such carrier may be in the form of a CD ROM disc. It is however feasible with other data carriers such as a memory stick. The computer program code may furthermore be provided as pure program code on a server and downloaded to the target network node or the source network node.

The target network node or the source network node may further comprise a memory 550 in the target network node depicted in FIG. 5, and a memory 740 in the source network node 111 depicted in FIG. 7, comprising one or more memory units. The memory is arranged to be used to store obtained information, store data, configurations, schedulings, and applications etc. to perform the methods herein when being executed in the target network node or the source network node.

Those skilled in the art will also appreciate that the receiving circuit, sending circuit, Timer handling circuit, Mobility parameter handling circuit, and Associating circuit described above may refer to a combination of analog and digital circuits, and/or one or more processors configured with software and/or firmware, e.g. stored in the memory, that when executed by the one or more processors such as the processors in the target network node or the source network node perform as described above. One or more of these processors, as well as the other digital hardware, may be included in a single application-specific integrated circuitry (ASIC), or several processors and various digital hardware may be distributed among several separate components, whether individually packaged or assembled into a system-on-a-chip (SoC).

When using the word “comprise” or “comprising” it shall be interpreted as non-limiting, i.e. meaning “consist at least of”.

The embodiments herein are not limited to the above described preferred embodiments. Various alternatives, modifications and equivalents may be used. Therefore, the above embodiments should not be taken as limiting the scope of the invention, which is defined by the appending claims.

### ABBREVIATIONS

3GPP 3rd Generation Partnership Project

CN Core Network

UTRAN Universal Terrestrial Radio Access Network

GERAN GSM EDGE Radio Access Network

HO Hand Over

MRO Mobility Robustness Optimization

IRAT inter-RAT

LTE Long Term Evolution

RAT Radio Access Technology

eNB evolved Node B

RNC Radio Network Controller

UE User Equipment

RSRP Reference Signal Received Power

RSRQ Reference Signal Received Quality

1-28. (canceled)

29. A method in a target network node for applying mobility parameters, the target network node being configured with one or more first mobility parameters, the method comprising:
receiving a first message from a source network node, which first message comprises an indication, indicating one or more second mobility parameters associated with a first group of User Equipments, UEs, that are to be handed over from the source network node to the target network node; and
applying the one or more second mobility parameters for each or any respective User Equipment, UE, of the first group of UEs, being handed over from the source network node to the target network node during a time window.

30. The method according to claim 29, wherein the one or more second mobility parameters further are applied for each or any other respective UE being handed over from the source network node to the target network node during the time window.

31. The method according to claim 29, wherein the one or more second mobility parameters comprises a hand over trigger change and the time window.

32. The method according to claim 29, wherein the one or more second mobility parameters comprises a hand over trigger change, and wherein the target network node is configured with the time window.

33. The method according to claim 29, further comprising:
when the target network node has been configured with the one or more second mobility parameters indicated in the first message, starting a first timer of the time window.

34. The method according to claim 33, further comprising:
when the first timer has expired, applying the one or more first mobility parameters for each or any respective UE of the first group of UEs, and each or any other respective UE being handed over from the source network node to the target network node.

35. The method according to claim 29, further comprising:
during the time window, applying further a classification algorithm of the source network node, which classification relates to dividing UEs into groups, and
when the first timer has expired, applying further a classification algorithm of the target network node.

36. The method according to claim 29, wherein the first message further indicates a group ID associated with the first group of UEs.

37. The method according to claim 36, wherein the first message further comprises a respective group ID for one or more second groups of UEs and indicates one or more third mobility parameters associated with the respective one or more second group of UEs, the method further comprising:
creating a list of groups of UEs comprising the first group of UEs and the one or more second group of UEs, and the group ID and associated mobility parameters of the respective groups of UEs.

38. A method in a source network node for proposing mobility parameters to a target network node, the method comprising:
associating one or more second mobility parameters and a group ID with a first group of User Equipments, UEs, that is to be handed over to a target network node; and
sending a first message to the target network node, which first message comprises an indication indicating the first group of UEs that are to be handed over to the target network node, and which first message further indicates the one or more second mobility parameters associated with the group of UEs.

39. The method according to claim 38, wherein the one or more second mobility parameters are proposed to the target network node.

40. The method according to claim 38, wherein the first message further comprises an indication indicating the group ID associated with the group of UEs that are to be handed over to the target network node.

41. The method according to claim 38, wherein the one or more second mobility parameters comprises a hand over trigger change, or wherein the one or more second mobility parameters comprises a hand over trigger change and a time window, during which time window the target node shall apply the one or more second mobility parameters for each or any respective User Equipment, UE, of the first group of UEs, being handed over from the source network node to the target network node.

42. The method according to claim 38, wherein the first message further comprises a respective group ID for one or more second groups of UEs and indicates one or more third mobility parameters associated with the respective one or more second group of UEs.

43. A target network node for applying mobility parameters, the target network node being configured with one or more first mobility parameters, the target network node comprising:
a receiving circuit configured to receive a first message from a source network node, which first message comprises an indication, indicating one or more second mobility parameters associated with a first group of User Equipments, UEs, that are to be handed over from the source network node to the target network node; and
a mobility parameter handling circuit configured to apply the one or more second mobility parameters for each or any respective User Equipment, UE, of the first group of UEs, being handed over from the source network node to the target network node during a time window.

44. The target network node according to claim 43, wherein the mobility parameter handling circuit further is configured to apply the one or more second mobility parameters for each or any other respective UE being handed over from the source network node to the target network node during the time window.

45. The target network node according to claim 43, wherein the one or more second mobility parameters comprises a hand over trigger change and the time window.

46. The target network node according to claim 43, wherein the one or more second mobility parameters comprises a hand over trigger change, and wherein the target network node is configured with the time window.

47. The target network node according to claim 43, further comprising:
a timer handling circuit configured to start a first timer of the time window when the target network node has been configured with the one or more second mobility parameters indicated in the first message.

48. The target network node according to claim 47, further comprising:
wherein the mobility parameter handling circuit further is configured to, when the first timer has expired, apply the one or more first mobility parameters for each or any respective UE of the first group of UEs, and each or any other respective UE being handed over from the source network node to the target network node.

49. The target network node according to claim 43, wherein the mobility parameter handling circuit further is configured to:
during the time window, apply a classification algorithm of the source network node, which classification relates to dividing UEs into groups, and
when the first timer has expired, apply a classification algorithm of the target network node.

50. The target network node according to claim 43, wherein the first message further indicates a group ID associated with the first group of UEs.

51. The target network node according to claim 50, wherein the first message further comprises a respective group ID for one or more second groups of UEs and indicates one or more third mobility parameters associated with the respective one or more second group of UEs, the target network node further comprising:
a processor configured to create a list of groups of UEs comprising the first group of UEs and the one or more second group of UEs, and the group ID and associated mobility parameters of the respective groups of UEs.

52. A source network node for proposing mobility parameters to a target network node, the source network node comprising:
an associating circuit configured to associate one or more second mobility parameters and a group ID with a first group of User Equipments, UEs, that is to be handed over to a target network node; and
a sending circuit configured to send a first message to the target network node, which first message comprises an indication indicating the first group of UEs that are to be handed over to the target network node, and which first message further indicates the one or more second mobility parameters associated with the group of UEs.

53. The source network node according to claim 52, wherein the one or more second mobility parameters are to be proposed to the target network node.

54. The source network node according to claim 52, wherein the first message further comprises an indication indicating the group ID associated to the group of UEs that are to be handed over to the target network node.

55. The source network node according to claim 52, wherein the one or more second mobility parameters comprises a hand over trigger change, or wherein the one or more second mobility parameters comprises a hand over trigger change and a time window, during which time window the target node shall apply the one or more second mobility parameters for each or any respective User Equipment, UE, of the first group of UEs, being handed over from the source network node to the target network node.

56. The source network node according to claim 52, wherein the first message further comprises a respective group ID for one or more second groups of UEs and indicates one or more third mobility parameters associated with the respective one or more second group of UEs.
